(19) United States
(12) Patent Application Publication
(10) Pub. No.: US 2012/0287818 A1
(43) Pub. Date: Nov. 15, 2012

(54) MULTIPOINT-TO-MULTIPOINT SERVICE FOR A COMMUNICATIONS NETWORK

(75) Inventors: Andrea Corti, Varazze (IT); Raoul Fiorone, Genova (IT); Riccardo Martinotti, Savona (IT)

(73) Assignee: TELEFONAKTIEBOLAGET L M ERICSSON (PUBL), STOCKHOLM (SE)

(21) Appl. No.: 13/502,065

(22) PCT Filed: Oct. 20, 2009
(86) PCT No.: PCT/EP2009/063708

§ 371 Date: Aug. 3, 2012

(30) Foreign Application Priority Data
Oct. 13, 2009 (EP) 09172854.3

(51) Int. Cl. H04L 12/28

(52) U.S. Cl. 370/254

(57) ABSTRACT

A multipoint-to-multipoint service is provided between a set of edge nodes of a communications network. The network comprises at least two sub-networks and an intermediate node at a boundary between sub-networks. For each pair of edge nodes comprising an edge node in a first of the sub-networks and an edge node in a second of the sub-networks, a multi-segment pseudowire connection is configured between the pair of edge nodes. The pseudowire connection passing via at least one intermediate node. At the intermediate node forwarding data is configured which specifies a forwarding relationship between pseudowire segments corresponding to the multi-segment pseudowire connections. A topology of Label Switched Paths carry the multi-segment pseudowires. Edge nodes within a sub-network can be connected with a mesh topology or a hub-and-spoke topology.

### TECHNICAL FIELD

This invention relates to providing the support of multipoint-to-multipoint services, such as a Virtual Private LAN Service (VPLS), over a communications network.

### BACKGROUND

Packet Switched networks are replacing legacy Time Division Multiplexing (TDM) based networks for their capability to handle in a more optimized and flexible way data traffic, such as Ethernet and Internet Protocol (IP). A type of connectivity which can be implemented on a packet switched network is a multipoint-to-multipoint service. A type of multipoint-to-multipoint service is a Virtual Private LAN Service (VPLS). A set of nodes are interconnected in a multipoint-to-multipoint manner such a way that they appear to form a virtual private Local Area Network.

Several existing methods are known for providing a VPLS over a packet switched network: flat VPLS and Hierarchical VPLS. In a “flat” VPLS, multiple customer sites can communicate with each other as if they were connected to a private Ethernet LAN segment. The VPLS service is defined by establishing a full mesh of connections, called Pseudowires (PW) between all edge nodes forming part of the VPLS. This is shown in FIG. 1. When a Customer Equipment (CE) transmits a frame, the Provider Edge (PE) node examines the MAC Destination Address in the frame to determine where to forward the frame. Thus, the PE node acts as a bridge and provides a logical interconnection such that each CE belonging to a particular VPLS appears to be connected by a single LAN. Devices which belong to the VPLS must be capable of MAC address learning and forwarding. A significant drawback of a flat VPLS is the requirement for a full mesh of PWs interconnecting PE nodes. This also requires a full mesh of LSPs to provide a transport layer for the pseudowires. In the example of FIG. 1, a full mesh of PWs and LSPs is created between PE1-PE6.

It can be difficult to implement the flat VPLS across multiple network domains. Where protection of traffic is required, considerable effort is needed to manage protection instances. End-to-end protection of the pseudowires extending end-to-end across multiple domains can be problematic. In summary, VPLS suffers from scalability issues when the number of its edge nodes becomes high.

Another form of VPLS is Hierarchical VPLS (H-VPLS). H-VPLS creates a full mesh of connections only in the core sub-network or inside each sub-network. FIG. 2 shows a first implementation of H-VPLS and the set of PW and LSP connections required to provide a VPLS for the same set of nodes PE1-PE6. A full mesh of PWs and LSPs is created between PEs inside the Core area. Similarly, nodes within each metro network are interconnected with a mesh of PWs and LSPs. FIG. 3 shows a variant of FIG. 2, where the nodes within each Metro area A, B and C are connected using a hub and spoke topology with a core PE node. In FIG. 3 a connection between nodes PE1 and PE2 is made via node PE7, whereas in FIG. 2 a direct connection is made between PE1 and PE2.

In an H-VPLS PW and LSP connections only traverse a single network domain. Intermediate nodes PE7, PE8, PE9 must forward traffic between a PW in a Metro network and a PW in the core network, and vice versa. So, traffic between PE2 and PE3 will arrive at PE7. PE7 must forward traffic along the PW between PE7 and PE8. PE7 inspects the MAC address carried within each packet to determine how to forward each packet. This requires each nodes PE7-PE9 to store a MAC forwarding table. This can be a considerable burden on the intermediate nodes, requiring storage and computation resources as well as incurring a forwarding delay. For the network shown in FIG. 3, the MAC forwarding table at node PE7 may be required to be aware of all MAC addresses used in each of the networks 11-14, and possibly of CE devices connected to the networks 11-14. This can pose serious scalability issues, especially if no MAC-in-MAC (Provider Backbone Bridge—PBB) or MAC Address Translation (MAT) is performed in the overall network.

The present invention seeks to provide an alternative way of providing a Virtual Private LAN Service (VPLS) over a communications network.

### SUMMARY

An aspect of the present invention provides a method of providing a multipoint-to-multipoint service between a set of edge nodes of a communications network, the network comprising at least two sub-networks and an intermediate node at a boundary between sub-networks, the method comprising:

configuring, for each pair of edge nodes comprising an edge node in a first of the sub-networks and an edge node in a second of the sub-networks, a multi-segment pseudowire connection between the pair of edge nodes, the pseudowire connection passing via at least one intermediate node;

configuring, at the at least one intermediate node, forwarding data which specifies a forwarding relationship between pseudowire segments corresponding to the multi-segment pseudowire connections.

This aspect of the invention provides a way of implementing a multipoint-to-multipoint service, such as a Virtual Private LAN Service (VPLS), over a connection-oriented network. An advantage of using multi-segment pseudowire connections is that the multipoint-to-multipoint service can be provided across a network comprising multiple domains, with the possibility of a protection mechanism per segment. Another advantage of using multi-segment pseudowire connections, end-to-end, between pairs of edge nodes is that it reduces the resources required in the intermediate nodes at boundaries between sub-networks. An intermediate node is only required to switch traffic between pseudowire segments. This considerably reduces the required resources at the intermediate node compared to MAC-based switching as performed in a conventional H-VPLS network.

Each sub-network can be a network domain (e.g. a part of a network under control of a particular Administrative Authority), a part of a network having a particular network type or a part of the network using a particular network technology (e.g. MPLS or MPLS-TP). The multi-segment pseudowires can be carried end-to-end across a network comprising different domains and/or technologies.

Advantageously, the pseudowire segments of the multi-segment pseudowires are carried along Label Switched Paths (LSP) within the network, with a respective pseudowire segment of each of a plurality of the multi-segment pseudowires following a common Label Switched Path (LSP) between nodes. Carrying multiple pseudowires along a common LSP reduces the network resources needed to support the service.

The communications network can have a hub-and-spoke topology, or a full mesh topology, of Label Switched Paths between edge nodes and intermediate nodes.

Edge nodes of a sub-network can be directly connected via single segment pseudowire (SS-PW) connections. Alternatively, edge nodes of a sub-network can be connected via a multi-segment pseudowire (MS-PW) connection which passes via an intermediate node, which has an advantage of reducing the network resources required to support the service, particularly when the pseudowire segments of the multi-segment pseudowire connection are carried by a LSP used by other pseudowire segments.

Another aspect of the invention provides a method of configuring a first intermediate node to implement a multipoint-to-multipoint service between a set of edge nodes of a communications network, the network comprising at least two sub-networks and the first intermediate node at a boundary between sub-networks, with a multi-segment pseudowire connection configured for each pair of edge nodes comprising an edge node in a first of the sub-networks and an edge node in a second of the sub-networks, at least one of the multi segment pseudowire connections passing via the first intermediate node, the method comprising:

configuring, at the first node, forwarding data which specifies a forwarding relationship between pseudowire segments corresponding to the multi-segment pseudowire connection between edge nodes.

Another aspect of the invention provides a method of traffic forwarding at a first intermediate node of a communications network in which a multipoint-to-multipoint service is established between a set of edge nodes, the network comprising at least two sub-networks and the first node at a boundary between sub-networks, with a multi-segment pseudowire connection configured for each pair of edge nodes comprising an edge node in a first of the sub-networks and an edge node in a second of the sub-networks, at least one of the multi segment pseudowire connections passing via the first intermediate node, the method comprising:

receiving a traffic unit with information which identifies the pseudowire segment;

forwarding traffic to another pseudowire segment based on the received information which identifies the pseudowire segment and forwarding data stored at the first intermediate node.

An advantage of this aspect is that the intermediate node is only required to switch traffic between pseudowire segments. This considerably reduces the required resources at the intermediate node compared to MAC-based switching as performed in a conventional H-VPLS network.

Another aspect of the invention provides a method of configuring a first edge node of a communications network to implement a multipoint-to-multipoint service between a set of edge nodes, the network comprising at least two sub-networks and an intermediate node at a boundary between sub-networks, with a multi-segment pseudowire connection configured for each pair of edge nodes comprising the first edge node in a first of the sub-networks and an edge node in a second of the sub-networks, the multi segment pseudowire connections passing via an intermediate node, the method comprising:

configuring, at the first edge node, mapping data which specifies a mapping relationship between a network address corresponding to a traffic destination and an identifier of a multi-segment pseudowire connection.

The network address can be a network address of the destination edge node or a network address of a node served by the destination edge node. Where MAC-in-MAC encapsulation is used within a provider network, customer traffic is encapsulated at an edge node and packets carry an additional header with a destination address corresponding to one of the destination edge nodes of the provider network.

Further aspects of the invention provide apparatus to implement each of these methods.

An aspect of the invention provides apparatus for use at a first intermediate node of a communications network to provide a multipoint-to-multipoint service between a set of edge nodes of the communications network, the network comprising at least two sub-networks and the first intermediate node being positioned at a boundary between sub-networks, the apparatus comprising:

interfaces for interfacing with pseudowire segments of multi-segment pseudowire connections between nodes in the sub-networks, there being a multi-segment pseudowire connection for each pair of edge nodes comprising an edge node in a first of the sub-networks and an edge node in a second of the sub-networks;

a store for storing forwarding data which specifies a forwarding relationship between pseudowire segments of the multi-segment pseudowire connections;

an interface for receiving information to configure the forwarding data.

Another aspect of the invention provides apparatus for use at a first edge node of a communications network to provide a multipoint-to-multipoint service between a set of edge nodes of the communications network, the network comprising at least two sub-networks and an intermediate node at a boundary between sub-networks the apparatus comprising:

interfaces for interfacing with multi-segment pseudowire connections to edge nodes, there being a multi-segment pseudowire connection for each pair of edge nodes comprising the first edge node in a first of the sub-networks and an edge node in a second of the sub-networks, the multi segment pseudowire connections passing via an intermediate node;

a store for storing mapping data which specifies, for each of the multi-segment pseudowire connections, a mapping relationship between a network address corresponding to a traffic destination and an identifier of a multi-segment pseudowire connection.

The functionality described here can be implemented in software, hardware or a combination of these. The functionality can be implemented by means of hardware comprising several distinct elements and by means of a suitably programmed processing apparatus. The processing apparatus can comprise a computer, a processor, a state machine, a logic array or any other suitable processing apparatus. The processing apparatus can be a general-purpose processor which executes software to cause the general-purpose processor to perform the required tasks, or the processing apparatus can be dedicated to perform the required functions. Another aspect of the invention provides machine-readable instructions (software) which, when executed by a processor, perform any of the described methods. The machine-readable instructions may be stored on an electronic memory device, hard disk, optical disk or other machine-readable storage medium. The machine-readable instructions can be downloaded to a processing apparatus via a network connection.

### BRIEF DESCRIPTION OF THE DRAWINGS

Embodiments of the invention will be described, by way of example only, with reference to the accompanying drawings in which:

FIG. 1 shows an example of a flat VPLS between a set of nodes;

FIG. 2 shows an example of a hierarchical VPLS (H-VPLS) between a set of nodes;

FIG. 3 shows a variant of the H-VPLS of FIG. 2;

FIG. 4 shows a first variant of a VPLS between a set of nodes using multi-segment Pseudowires (MS-PWs);

FIG. 5 shows a variant of the VPLS of FIG. 4;

FIG. 6 shows the Pseudowire switching performed at an intermediate node of FIG. 4;

FIG. 7 shows the Pseudowire switching performed at an intermediate node of FIG. 5;

FIG. 8 shows the forwarding performed at an edge node of FIG. 4;

FIG. 9 shows the forwarding performed at an edge node of FIG. 5;

FIG. 10 shows steps of a method of configuring a VPLS;

FIG. 11 shows another example network with a VPLS formed using multi-segment Pseudowires (MS-PWs).

### DETAILED DESCRIPTION

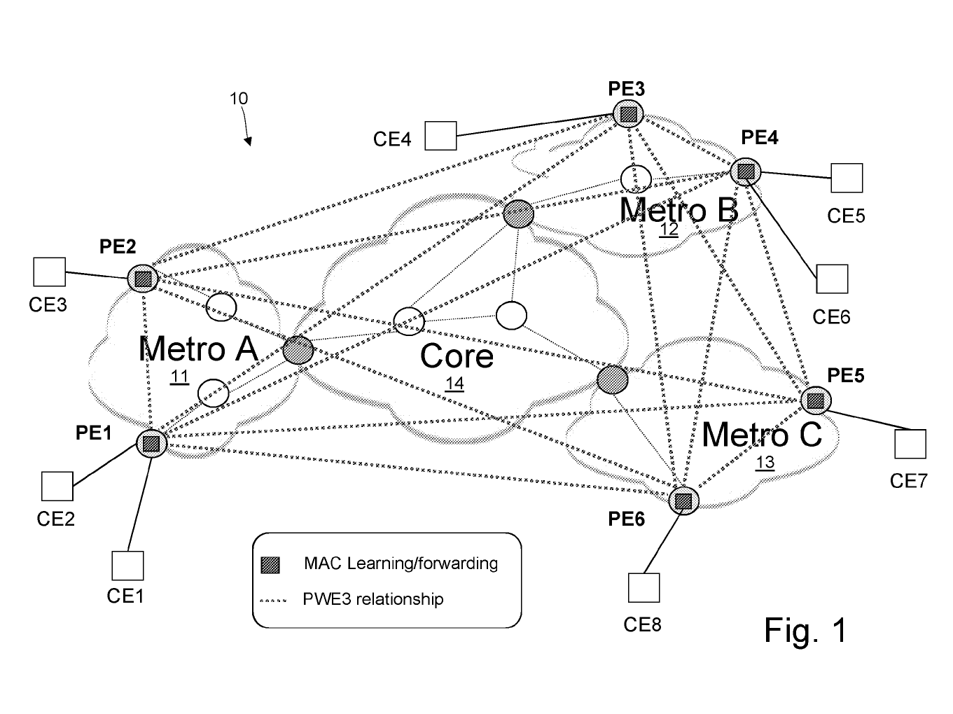

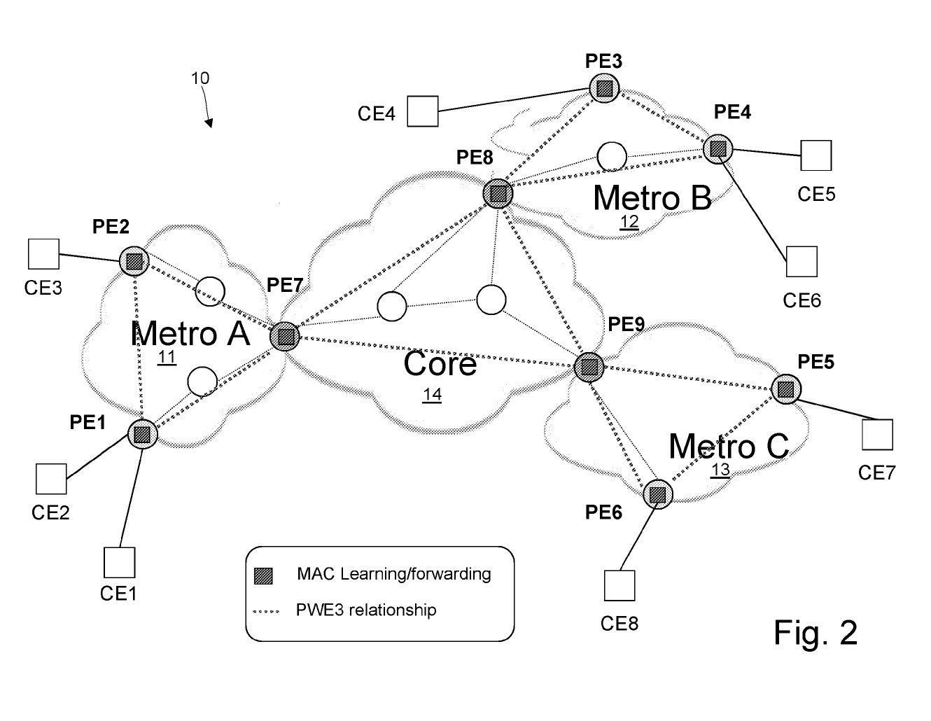

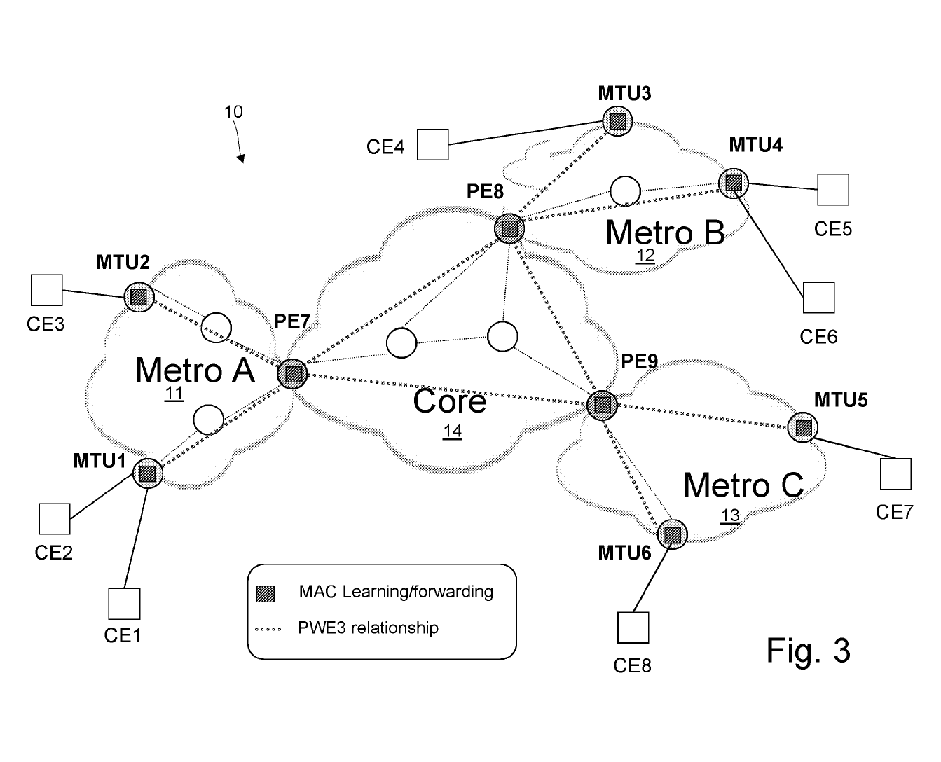

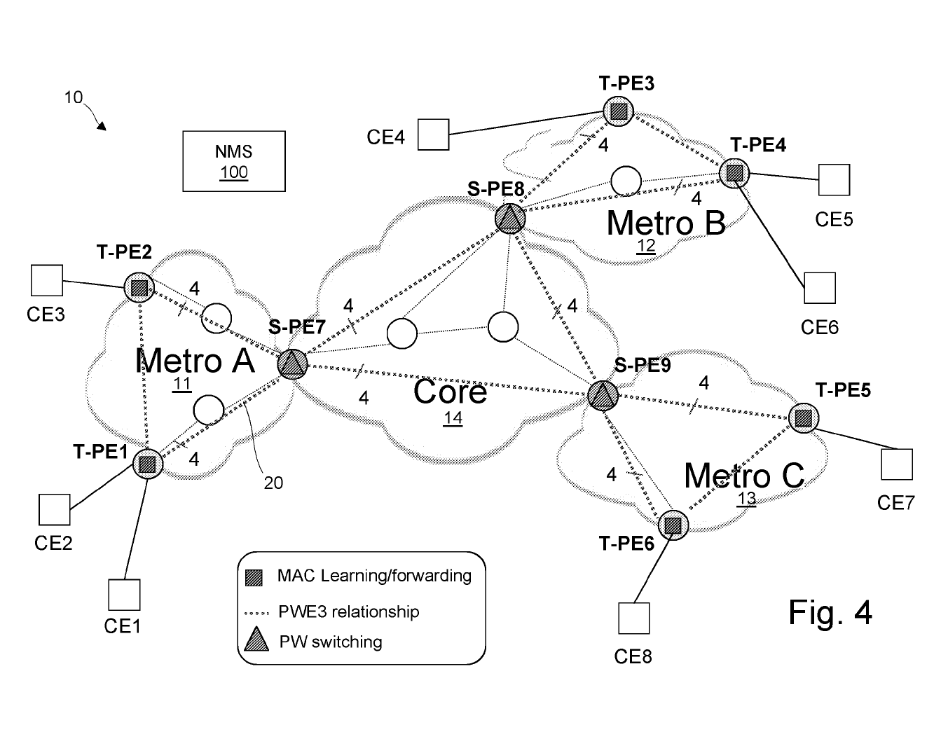

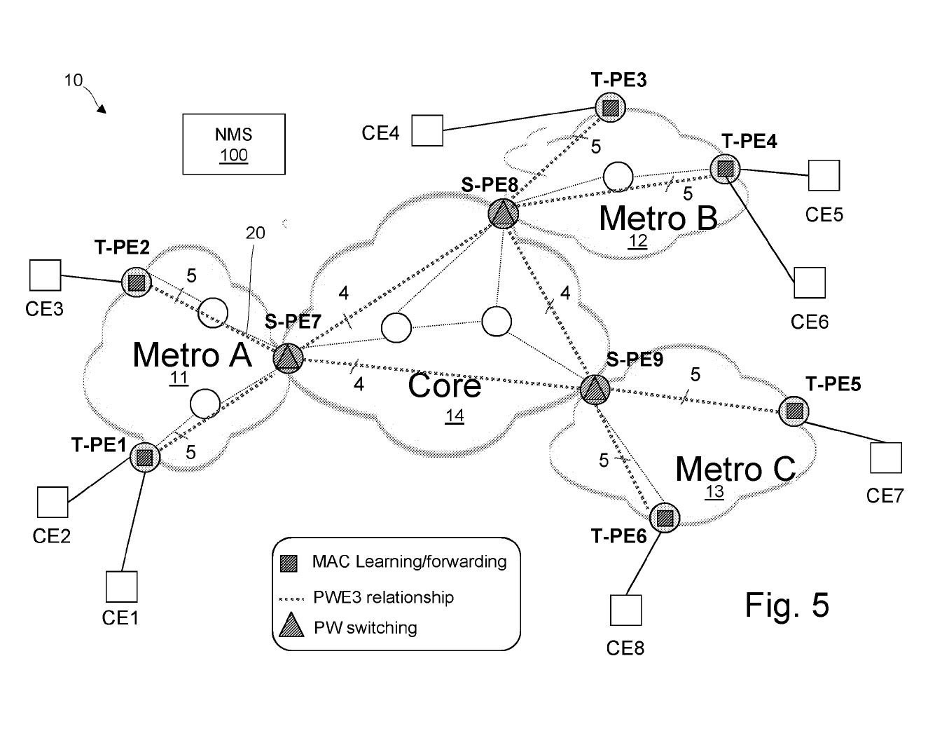

FIGS. 4 and 5 show examples of a network in which Multi-Segment Pseudowires (MS-PW) are used to provide a Virtual Private LAN Service (VPLS) across a network. For ease of comparison, FIGS. 4 and 5 show the same network as FIGS. 1-3. Metro networks 11-13 are each connected to a core network 14. Terminating Provider Edge (T-PE) nodes T-PE1-T-PE6 are located on the edge of metro networks 11-13. Metro networks typically serve access networks (not shown), with Terminating Provider Edge (T-PE) nodes connecting to Customer Edge (CE) nodes in an access network. Boundary nodes, called Switching-Provider Edge (S-PE) nodes, S-PE7, S-PE8, S-PE9, are located at boundaries between the core network 14 and metro networks 11-13.

In this example, nodes T-PE1-T-PE6 require VPLS connectivity. A set of Multi-Segment Pseudowires (MS-PW) are configured to form the VPLS. A MS-PW is configured to provide an end-to-end path between each pair of T-PE nodes. A Multi-Segment Pseudowire (MS-PW) comprises N “segments”, (where N≧2). Each segment is a Pseudowire portion between a pair of nodes. Considering the end-to-end path between node T-PE1 and T-PE3, this has the routing: T-PE1-S-PE7-S-PE8-T-PE3. There are three segments in total:
a segment in Metro A (from T-PE1 to S-PE7);
a segment in Core (from S-PE7 to S-PE8);
a segment in Metro B (from S-PE8 to T-PE3).
   For this MS-PW, the T-PE nodes are terminating nodes (endpoints) of the MS-PW and the S-PE nodes are PW switching nodes. A segment of a Multi-Segment Pseudowire is not terminated at S-PE nodes. Multi-Segment Pseudowires (MS-PW) are described in: RFC 5254 “Requirements for Multi-Segment Pseudowire Emulation Edge-to-Edge (PWE3)” and draft-ietf-pwe3-segmented-pw-11.txt, “Segmented Pseudowire”, Martini et al, Feb. 18, 2009.

A PW, which forms a segment of a MS-PW connection, is carried over a Label Switched Path (LSP). Accordingly, a set of LSPs are also required to transport the MS-PWs. LSP tunnels are terminated at S-PE nodes and traffic is switched between PWs.

MS-PWs and LSPs are routed via a selected set of intermediate nodes S-PE. Multiple MS-PWs follow the same routing, where applicable, with a single LSP carrying a “bundle” of segments belonging to different MS-PWs. A full mesh of LSP tunnels and PWs connect S-PE nodes in the Core area 14. There are two possible options for the topology of metro areas:
Option A. Each metro area 11-13 has a full mesh of PWs and LSP tunnels which connect T-PE nodes within the area, and connect T-PE nodes with the relevant S-PE node(s). This option is shown in FIG. 4. The number marked against each bundle of PWs denotes the number of PWs which follow that routing.
Option B. Each metro area 11-13 has a hub-and-spoke topology of connections, with each T-PE node connecting to a S-PE. Connections between a pair of T-PE nodes within the same area are routed via a S-PE node. This option is shown in FIG. 5.

To explain the connections that are configured, node T-PE1 will be considered in detail. For Option A (FIG. 4), the following connections are configured at node T-PE1:
MS-PW1: T-PE1-S-PE7-S-PE8-T-PE3
MS-PW2: T-PE1-S-PE7-S-PE8-T-PE4
MS-PW3: T-PE1-S-PE7-S-PE9-T-PE5
MS-PW4: T-PE1-S-PE7-S-PE9-T-PE6
SS-PW1: T-PE1-T-PE2
   The initial segments of MS-PW1-MS-PW4 follow the same routing between T-PE1 and S-PE7 and can be carried by a single LSP. SS-PW1 follows a direct routing between T-PE1 and T-PE2 and is carried by a different LSP.

For Option B (FIG. 5), the following connections are configured at node T-PE1:
MS-PW1: T-PE1-S-PE7-S-PE8-T-PE3
MS-PW2: T-PE1-S-PE7-S-PE8-T-PE4
MS-PW3: T-PE1-S-PE7-S-PE9-T-PE5
MS-PW4: T-PE1-S-PE7-S-PE9-T-PE6

MS-PW5: T-PE1-S-PE7-T-PE2

The initial segments of MS-PW1-MS-PW5 follow the same routing along between T-PE1 and S-PE7 and can be carried by a single LSP.

Both options provide full network connectivity among all T-PE nodes of different metro areas belonging to the VPLS service. In FIG. 4 there is a direct connection, SS-PW1, between nodes T-PE1 and T-PE2. In FIG. 5 the connection MS-PW5 between nodes T-PE1 and T-PE2 is routed via S-PE7. The topology shown in FIG. 5 allows the LSPs between T-PE1 and S-PE5, and between S-PE5 and T-PE2, to carry PW5, avoiding the need for a LSP routed T-PE1-T-PE2. A set of end-to-end MS-PW connections are configured at each of the other T-PE nodes. Each MS-PW connection is bi-directional.

In Option A, the S-PEs within a Metro area will directly manage the traffic exchange between them, whereas in Option B the T-PE will be responsible for the appropriate PW swapping also within each Metro area. The main difference between these two options is the number of LSPs required within each Metro area and the behaviour of T-PE nodes and S-PE nodes, which in Option B would act as “proxy” also for the traffic within the same Metro area. The choice between the two options is dependent on the network operator's requirements and network design, which must also take into account traffic engineering criteria.

Where a MS-PW crosses an area (e.g. from Metro A to the Core at node S-PE7) Pseudowire switching (and possibly label swapping) is performed. For end-to-end connections which span a single domain, a Single-Segment Pseudowire (SS-PW) can be used. Although MS-PW1-MS-PW4 have been described as being transported by a single LSP, they can be distributed across multiple LSPs, if desired. S-PE nodes perform PW switching so that full mesh connectivity is obtained for the whole network.

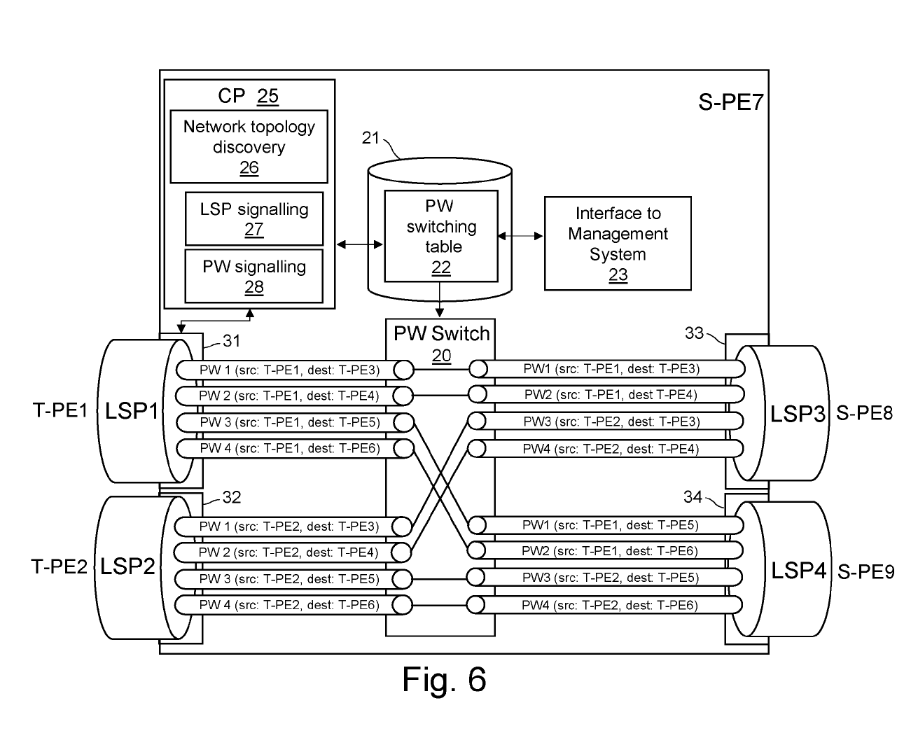

FIG. 6 schematically shows an S-PE node of the network 10. Node S-PE7 is shown as an example, and other S-PE nodes have the same form. FIG. 6 shows Pseudowire switching performed at node S-PE7 for the topology of FIG. 4 (Option A) where a direct connection exists between T-PE1 and T-PE2. S-PE7 has interfaces 31-34 for connecting to LSPs which connect with four destination nodes T-PE1, T-PE2, S-PE8, S-PE9. All LSPs terminate at node S-PE7. LSP termination means that the tunnel functionality provided by the LSP inside the transport network ends so that de-capsulation of traffic payload (PWs in this case) is performed. In practice, the transmission overhead is removed (i.e. LSP label(s) is stripped off) and PWs can be accessed and managed. A LSP carries a bundle of Pseudowires. LSP1 carries the bundle of MS-PWs between the source node T-PE1 and destination nodes T-PE3-T-PE6. The first PW segment of these PWs has the same routing over LSP1 between T-PE1 and S-PE7. A switch 20 switches traffic between pseudowires. The pseudowires form the different “segments” of the end-to-end Multi-Segment Pseudowires (MS-PW) between edge nodes T-PE. For ease of explanation, the PWs in FIG. 6 are each labelled with their respective source and destination T-PE nodes. However, it should be understood that the PW switching 20 performed at node S-PE7 does not make use of any identifier of the edge nodes. Instead, the PW switching 20 only uses a PW identifier, called a PW label, which is carried within the header of a PW data unit. A PW uses an MPLS label, as defined in RFC3032. A store 21 stores a PW switching table 22 which specifies forwarding information which identifies a pair of PW labels corresponding to PW segments that traffic should be switched between. Each entry in the PW switching table 22 may also specify an identifier of a physical/logical port at the switch or an identifier of a LSP which carries a PW. An example switching table 22 which uses a combination of LSP identifier/port and PW label is shown below.

TABLE 1
Example Pseudowire switching table

| LSP | PW segment | LSP | PW segment |
|---|---|---|---|
| 1 | 1 | 3 | 1 |
| 1 | 2 | 3 | 2 |
| 1 | 3 | 4 | 1 |
| 1 | 4 | 4 | 2 |
| 2 | 1 | 3 | 3 |
| 2 | 2 | 3 | 4 |
| 2 | 3 | 4 | 3 |
| 2 | 4 | 4 | 4 |

There are various labelling conventions for PWs. In one labelling convention, a combination of a port identifier and a PW label uniquely identifies a PW segment at the switch 20. This is a per interface PW label assignment. In FIG. 6 each LSP (LSP1-LSP4) is shown carrying a set of PW segments with the PW labels PW1-PW4. The same set of PW labels can be re-used by PWs on different LSPs. A combination of port and PW label is used as a PW label, by itself, is not sufficient to uniquely identify a PW segment.

In another labelling convention each PW has a unique label at a switch 20. This is a per platform PW label assignment. Accordingly, the PW label, by itself, is sufficient to uniquely identify a PW segment and switching table 22 only stores pairs of PW labels corresponding to PW segments that traffic should be switched between.

FIG. 6 shows other functional units at an S-PE node. If a Control Plane (CP) is running on the network, a Control Plane module 25 manages the setup of the transport infrastructure. Signalling and set up of PWs (PW1-PW4) and LSPs (LSP1-LSP4) is performed by the LSP signalling module 27 and a PW signalling module 28. CP signalling is sent to, and received from, interfaces 31-34 (a signalling path is only shown between CP module 25 and interface 31 for clarity). A Network topology discovery function 26 can be used to find and create a path within the network. Stitching of PWs from a first sub-network to a second sub-network can be performed by the CP module 25. CP module 25 is responsible for managing the PW switching table 22 and will add new entries to the switching table 22 when new connections are configured and will remove entries from the switching table 22 when connections are torn down. In addition to the Control Plane, or instead of the Control Plane, connections can be configured by a Network Management System (NMS) 100 via an interface 23. Each S-PE node along a required path adds entries to its respective switching table 22.

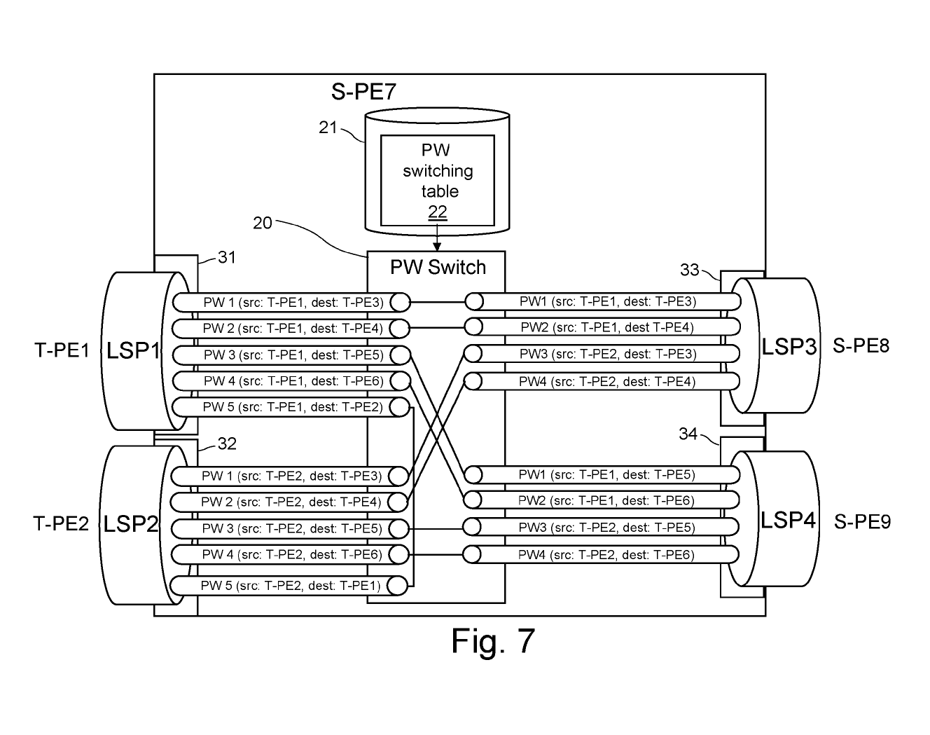

FIG. 7 shows the Pseudowire switching performed at node S-PE7 for the topology shown in FIG. 5 (Option B). This is very similar to FIG. 6, except that an additional PW segment (PW5) is carried by the LSP (LSP1) that connects S-PE7 and T-PE1 and an additional PW segment (PW5) is carried by the LSP (LSP2) that connects S-PE7 and T-PE2. Node S-PE7 switches traffic between these PWs, to provide a connection between T-PE1 and T-PE2. The other functional units of the S-PE node, shown in FIG. 6, are also present but are omitted from FIG. 7 for clarity. In both FIGS. 6 and 7 the S-PE node does not need to store, or use, a MAC forwarding table as all forwarding is performed on the basis of table entries which relate to pairs of PW segments.

TABLE 2
Example Pseudowire switching table

| LSP | PW segment | LSP | PW segment |
|---|---|---|---|
| 1 | 1 | 3 | 1 |
| 1 | 2 | 3 | 2 |
| 1 | 3 | 4 | 1 |
| 1 | 4 | 4 | 2 |
| 1 | 5 | 2 | 5 |
| 2 | 1 | 3 | 3 |
| 2 | 2 | 3 | 4 |
| 2 | 3 | 4 | 3 |
| 2 | 4 | 4 | 4 |
| 2 | 5 | 1 | 5 |

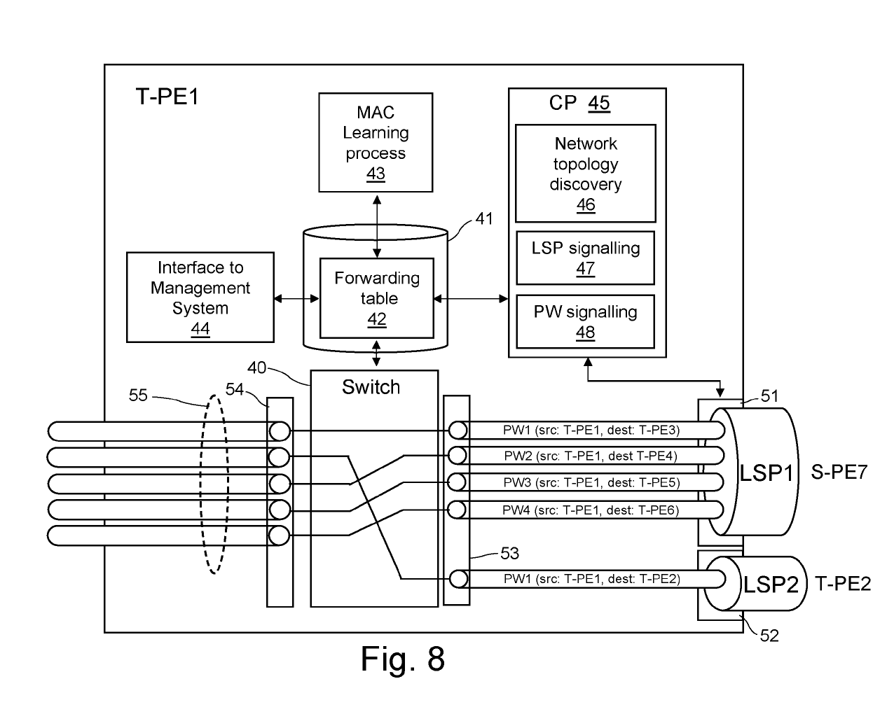

FIG. 8 schematically shows a T-PE node of the network 10. Node T-PE1 is shown as an example, and other T-PE nodes have the same form. T-PE1 has interfaces 51, 52 for connecting to boundary node S-PE7 and edge node T-PE2. FIG. 8 shows forwarding performed at node T-PE1 for the topology shown in FIG. 4 (Option A) where a direct connection exists between T-PE1 and T-PE2. A LSP connects with each of the destination nodes, with a LSP carrying one or more Pseudowires. LSP1 carries the bundle of PWs between T-PE1 and S-PE7. LSP2 carries the PW connection with T-PE2. T-PE1 also has interfaces 54 with a plurality of customer connections 55, which connect with nodes in an access network. Switch 40 forwards traffic between customer interfaces 50 and PWs. A store 41 stores a forwarding table 42 which specifies forwarding information to control operation of the switch 40. An example forwarding table is shown in FIG. 8. Each packet received at node T-PE1 carries a MAC address of the traffic destination. T-PE1 inspects the MAC address and performs a look-up in table 41. Table 42 stores, for each MAC address, an output interface which, in this example, will be one of the PWs PW1-PW4 carried by LSP1, or PW1 carried by LSP2. Of course, T-PE1 can also switch other traffic. Table 42 only shows entries relevant to this VPLS. Traffic is forwarded along the PW specified in table 42. An example forwarding table 42 is shown below, where the MAC addresses A-E correspond to traffic destinations.

TABLE 3
Example forwarding table

| MAC Address | PW label | LSP |
|---|---|---|
| A | 1 | 1 |
| B | 2 | 1 |
| C | 3 | 1 |
| D | 4 | 1 |
| E | 1 | 2 |

As previously described, there are various labelling conventions for PWs. In a per interface PW labelling convention, a combination of a PW label and a port identifier (or LSP identifier) uniquely identifies a PW at the switch 40. In a per platform PW labelling assignment each PW has a unique label at the switch 40. In both cases, forwarding table 42 stores information which associates a destination MAC address with a particular one of the pseudowires (MS-PW or SS-PW) terminated at the switch 40.

FIG. 8 shows other functional units at a T-PE node. If a Control Plane (CP) is running on the network, a Control Plane module 45 manages the setup of the transport infrastructure. Signalling and set up of PWs (PW1-PW4) and LSPs (LSP1, LSP2) is performed by a LSP signalling module 47 and a PW signalling module 48. A Network topology discovery function 46 can be used to find and create a path within the network. CP signalling is sent to, and received from, interfaces 51, 52. In addition to the Control Plane, or instead of the Control Plane, connections can be configured by a Network Management System (NMS) 100 via an interface 43.

Entries in the forwarding table 42 at each T-PE node can be created by a MAC flooding and learning mechanism, or by direct configuration by a NMS. A source T-PE will initially receive a frame from the customer with a certain destination MAC address (DMAC), which is not one of the MAC addresses currently stored in the forwarding table 42. Packets are sent over MS-PWs associated to the VPLS service using a flooding mechanism as it is not currently known which MS-PW should be used to deliver traffic to that DMAC. The destination will reply with some traffic on a particular one of the MS-PWs. At this point the source T-PE has learnt which MS-PW to use to reach the DMAC. An entry is added to the forwarding table 42. All frames with that DMAC are sent along the learnt MS-PW, specified in the forwarding table 42 until an ageing time expires. Expiry of an ageing period forces a new learning cycle and helps to keep the forwarding table up-to-date with the current topology of the network. In the case of manual configuration of MAC addresses to MS-PWs the flooding and learning steps are not required. This mechanism applies to both the MS-PWs for inter-domain connections and SS-PWs used for intra-domain connections.

PWs from the sub-network are terminated 53 before traffic is switched by switch 40. Traffic switching and forwarding is based on information contained in the forwarding table 42. Population of the Forwarding table 42 with the association of MAC address and traffic directions is based on the known Ethernet MAC learning process.

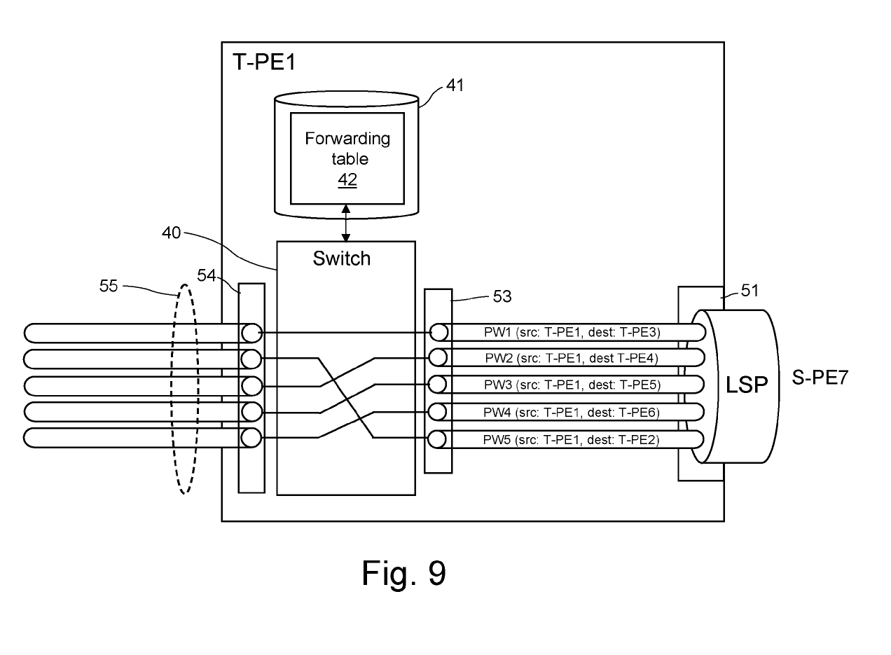

FIG. 9 shows forwarding performed at node T-PE1 for the topology shown in FIG. 5 (Option B). Node T-PE1 has an interface 51 for connecting to boundary node S-PE7. LSP1 carries a bundle of PWs between T-PE1 and S-PE7. The other functional units of the T-PE node, shown in FIG. 8, are also present but are omitted from FIG. 9 for clarity. Traffic between T-PE1 and T-PE2 is carried by PW5. An example forwarding table 42 is shown below, where the MAC addresses A-E correspond to traffic destinations.

TABLE 4
Example forwarding table

| MAC Address | PW segment | LSP |
|---|---|---|
| A | 1 | 1 |
| B | 2 | 1 |
| C | 3 | 1 |
| D | 4 | 1 |
| E | 5 | 1 |

The MAC address stored in forwarding table 42 can represent the final destination of traffic (e.g. a Customer Edge node, or device), a destination T-PE node, or a node which is positioned between the destination T-PE node and final traffic destination. The significance of the MAC address will depend on whether some form of MAC encapsulation (called MAC-in-MAC) is being used in network 10. Node T-PE1 only needs to inspect the “outermost” MAC address, where MAC encapsulation is in use.

MS-PWs are terminated 53 at T-PE nodes. At a T-PE node traffic is received from each MS-PW. The node inspects the MAC header of packets to determine which customer port (in that VPLS) the traffic needs to be forwarded to. The node then forwards packets along the correct customer interface.

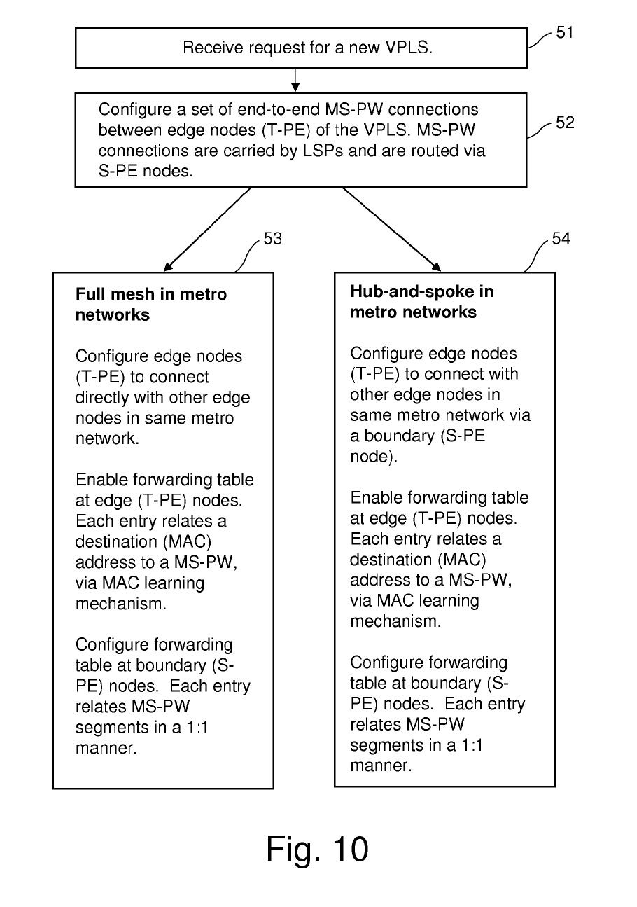

FIG. 10 summarises a method of forming a VPLS. The method begins at step 51 with a request to form a new VPLS between a set of edge (T-PE) nodes. At step 52 a set of end-to-end MS-PW connections are configured between edge nodes (T-PE) of the VPLS. The detail of how the VPLS is configured will vary depending on whether a full mesh topology is required in the metro networks (Option A, step 53) or a hub-and-spoke topology is required in the metro networks (Option B, step 54.) At step 53 edge nodes (T-PE) are configured to connect directly with other edge nodes in the same metro network. A forwarding table is configured at edge (T-PE) nodes. As explained above, a new entry for the forwarding table at edge nodes is typically created by a flooding and learning mechanism. A forwarding table entry is also configured at each boundary node (S-PE) along the path of each of the newly configured MS-PWs. Each entry relates MS-PW segments in a 1:1 manner. Step 54 is the same as step 53, apart from edge nodes (T-PE) are configured to connect with other edge nodes in same metro network via a boundary node (S-PE).

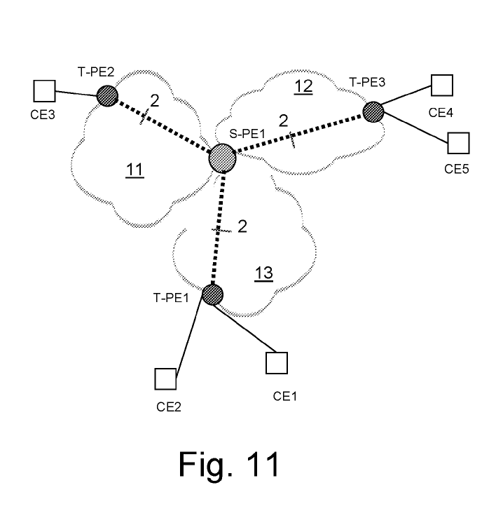

The example network shown in FIGS. 4 and 5 has a core are 14 and metro areas 11-13. The architecture can also be applied to smaller networks. FIG. 11 shows an example of a network with just metro areas 11-13 and three edge nodes T-PE1, T-PE2, T-PE3 which require VPLS connectivity. A single boundary node S-PE1 connects to the metro areas 11-13. In the same manner as previously described, a VPLS is formed between the set of edge nodes T-PE1, T-PE2, T-PE3 by configuring a MS-PW between each pair of edge nodes and LSPs to transport the PWs forming segments of the MS-PWs. At boundary node S-PE1, traffic is switched between PWs.

The architecture can also be applied to larger networks, with a larger number of core nodes, and networks with a larger number of sub-networks/areas/domains.

Emulation of LAN services within each Metro 11-13 area is based on VPLS functionality; in case of Option A, each T-PE node performs MAC learning/filtering in order to forward traffic to the right destination. Option B will make instead use of the solution proposed by the current invention for all traffic connections, so that each T-PE node must use MAC learning/filtering to forward traffic onto the right direction PW towards the “proxy” S-PE node.

In the MS-VPLS two different behaviours can be associated to PE nodes. T-PE nodes perform MAC switching functionality, while S-PE nodes perform PW switching so they do not need to manage MAC address tables, thereby reducing computation complexity and increasing scalability. The use of S-PE nodes has the advantage to create a hierarchy in the network so that different domains can be supported.

Protection mechanisms can be supported for each segment of the network, so that, as required in multi-domain networks, a fail which occurs in one domain does not affect the others.

The VPLS can be provisioned via a Management Plane (e.g. using with LCT/EMS/NMS) or via a Control Plane (with possible further extensions of LDP or BGP). Although FIGS. 4 and 5 show a single Network Management System (NMS) 100, there can be multiple NMS entities. Typically, each network domain will have an NMS entity, with communication between NMS entities.

Compared to VPLS, the MS-VPLS architecture described in FIGS. 4 to 10 is advantageous as it reduces the need for a full mesh network infrastructure of PWs and LSPs required by VPLS. MS-VPLS uses LSP connectivity similar to that of H-VPLS. MS-VPLS allows E-LAN services over multi-domain MPLS/MPLS-TP network, while VPLS is restricted to one domain only. MS-VPLS allows segment protection mechanisms, which are not possible in case of VPLS.

Compared to H-VPLS, the MS-VPLS architecture described in FIGS. 4 to 10 is advantageous as it reduces the resources required in S-PE nodes, with only PW switching required. This can have a significant scaling improvement with respect to H-VPLS, where Customer MAC address switching is needed. MS-VPLS does not require the network, or PE nodes themselves, to implement other mechanisms, like MAC-in-MAC (PBB) or MAT, to allow scalability in terms of MAC addresses. MS-VPLS provides end-to-end PW OAM of MPLS(-TP), while H-VPLS must use ETH OAM, so fault detection/inspection is less efficient.

Modifications and other embodiments of the disclosed invention will come to mind to one skilled in the art having the benefit of the teachings presented in the foregoing descriptions and the associated drawings. Therefore, it is to be understood that the invention is not to be limited to the specific embodiments disclosed and that modifications and other embodiments are intended to be included within the scope of this disclosure. Although specific terms may be employed herein, they are used in a generic and descriptive sense only and not for purposes of limitation.

1. A method of providing a multipoint-to-multipoint service between a set of edge nodes of a communications network, the network comprising at least two sub-networks and an intermediate node at a boundary between sub-networks, the method comprising:
configuring, for each pair of edge nodes comprising an edge node in a first of the sub-networks and an edge node in a second of the sub-networks, a multi-segment pseudowire connection between the pair of edge nodes, the pseudowire connection passing via at least one intermediate node; and
configuring, at the at least one intermediate node, forwarding data which specifies a forwarding relationship between pseudowire segments corresponding to the multi-segment pseudowire connections.

2. The method according to claim 1 wherein pseudowire segments of the multi-segment pseudowires are carried along Label Switched Paths within the network, with a respective pseudowire segment of each of a plurality of the multi-segment pseudowires following a common Label Switched Path between nodes.

3. The method according to claim 1 wherein the communications network has a mesh topology of Label Switched Paths between intermediate nodes.

4. The method according to claim 1 wherein the communications network has a hub-and-spoke topology of Label Switched Paths between edge nodes and intermediate nodes.

5. The method according to claim 1 wherein there is a plurality of edge nodes in the first sub-network and the method further comprises configuring a single segment pseudowire connection between each pair of the plurality of edge nodes in the first sub-network.

6. The method according to claim 1 wherein there is a plurality of edge nodes in the first sub-network and a first intermediate node at a boundary of the first sub-network, the method further comprising configuring a multi-segment pseudowire connection between each pair of the plurality of edge nodes in the first sub-network via the first intermediate node.

7. The method according to claim 1 wherein each sub-network is one of: a network domain; a network type; and a part of the network using a particular network technology.

8. A method performed by a first intermediate node to implement a multipoint-to-multipoint service between a set of edge nodes of a communications network, the network comprising at least two sub-networks and the first intermediate node at a boundary between sub-networks, with a multi-segment pseudowire connection configured for each pair of edge nodes comprising an edge node in a first of the sub-networks and an edge node in a second of the sub-networks, at least one of the multi-segment pseudowire connections passing via the first intermediate node, the method comprising:
configuring, at the first intermediate node, forwarding data which specifies a forwarding relationship between pseudowire segments corresponding to the multi-segment pseudowire connection between edge nodes.

9. The method of claim 8, further comprising:
receiving a traffic unit with information which identifies a first pseudowire segment; and
forwarding traffic to another pseudowire segment based on the received information which identifies the first pseudowire segment and forwarding data stored at the first intermediate node.

10. A method performed by a first edge node of a communications network to implement a multipoint-to-multipoint service between a set of edge nodes, the network comprising at least two sub-networks and an intermediate node at a boundary between sub-networks, with a multi-segment pseudowire connection configured for each pair of edge nodes comprising the first edge node in a first of the sub-networks and an edge node in a second of the sub-networks, the multi-segment pseudowire connections passing via an intermediate node, the method comprising:
configuring, at the first edge node, mapping data which specifies a mapping relationship between a network address corresponding to a traffic destination and an identifier of a multi-segment pseudowire connection.

11. The method according to claim 10 wherein the network address is one of: a network address of the destination edge node, a network address of a node served by the destination edge node.

12. The method according to claim 10 wherein the network address is a MAC address.

13. The method according to claim 10 wherein the multipoint-to-multipoint service is a virtual private Local Area Network (LAN) service.

14. (canceled)

15. An apparatus for use at a first intermediate node of a communications network to provide a multipoint-to-multipoint service between a set of edge nodes of the communications network, the network comprising at least two sub-networks and the first intermediate node being positioned at a boundary between sub-networks, the apparatus comprising:
interfaces for interfacing with pseudowire segments of multi-segment pseudowire connections between nodes in the sub-networks, there being a multi-segment pseudowire connection for each pair of edge nodes comprising an edge node in a first of the sub-networks and an edge node in a second of the sub-networks;
a store for storing forwarding data which specifies a forwarding relationship between pseudowire segments of the multi-segment pseudowire connections; and
an interface for receiving information to configure the forwarding data.

16. An apparatus for use at a first edge node of a communications network to provide a multipoint-to-multipoint service between a set of edge nodes of the communications network, the network comprising at least two sub-networks and an intermediate node at a boundary between sub-networks the apparatus comprising:
interfaces for interfacing with multi-segment pseudowire connections to edge nodes, there being a multi-segment pseudowire connection for each pair of edge nodes comprising the first edge node in a first of the sub-networks and an edge node in a second of the sub-networks, the multi-segment pseudowire connections passing via an intermediate node; and
a store for storing mapping data which specifies, for each of the multi-segment pseudowire connections, a mapping relationship between a network address corresponding to a traffic destination and an identifier of a multi-segment pseudowire connection.

17. The apparatus according to claim 16 further comprising a module for learning the mapping relationships and storing the mapping relationships in the store.

18. A communications network comprising:
at least two sub-networks;
at least one intermediate node at a boundary between sub-networks;
a plurality of edge nodes;
a first configuration module arranged to configure, for each pair of edge nodes comprising an edge node in a first of the sub-networks and an edge node in a second of the sub-networks, a multi-segment pseudowire connection between the pair of edge nodes, the pseudowire connection passing via at least one intermediate node; and
a second configuration module arranged to configure, at the at least one intermediate node, forwarding data which specifies a forwarding relationship between pseudowire segments corresponding to the multi-segment pseudowire connections.
